(19) United States
(12) Patent Application Publication
(10) Pub. No.: US 2026/0034420 A1
(43) Pub. Date: Feb. 5, 2026

(54) HOCKEY PUCK SHOT CHARACTERISTICS

(71) Applicant: Barrett Jesness, Bagley, MN (US)

(72) Inventor: Barrett Jesness, Bagley, MN (US)

(21) Appl. No.: 18/794,283

(22) Filed: Aug. 5, 2024

(51) Int. Cl. A63B 60/46; A63B 69/00

(52) U.S. Cl. CPC A63B 60/46; A63B 69/0026; A63B 2220/40; A63B 2220/56; A63B 2220/62; A63B 2225/50

(57) ABSTRACT

Devices, systems, and methods for determining a number of shot characteristics associated with shooting a hockey puck are described herein. In some examples, one or more embodiments include a memory and a processor to execute instructions stored in the memory to determine shot characteristics including a shot time, a load time, a release time, and a shot score associated with shooting a hockey puck based upon data from a sensor, such as a pressure sensor and/or a force sensor, and an accelerometer on a bracket attached to a blade of a hockey stick.

### BACKGROUND

Interest in data analytics for improving athletic performance has increased due to the availability of technology, such as internet of thing (IoT) devices, to collect data associated with athletic performance. In the sport of hockey, improving a player's ability to shoot the puck is desirable in a player's development throughout all levels of hockey.

Systems to analyze a hockey player's shot have used cameras and/or radar guns to acquire data associated with a player's shot. These systems that use cameras and/or radar guns can be expensive, are limited in the data and analysis associated with a shot that they can provide and cannot be easily transported to the various environments, such as different ice sheets, a driveway, a garage, or other training facilities, where players practice shooting hockey pucks.

### BRIEF DESCRIPTION OF THE DRAWINGS

FIG. 1 is an example schematic representation of a system for determining a number of shot characteristics associated with shooting a hockey puck in accordance with one or more embodiments of the present disclosure.

FIG. 2 illustrates a number of inputs and outputs used when determining a number of shot characteristics associated with shooting a hockey puck in accordance with one or more embodiments of the present disclosure.

FIG. 3 is a flow diagram of a method for determining hockey puck shot characteristics in accordance with one or more embodiments of the present disclosure.

FIG. 4 is a graph illustrating sensor data and acceleration data used to determine hockey shot characteristics in accordance with one or more embodiments of the present disclosure.

FIG. 5A is a front view of a bracket, including a pressure sensor and an accelerometer, attached to a hockey stick used to determine a number of shot characteristics associated with shooting a hockey puck in accordance with one or more embodiments of the present disclosure.

FIG. 5B is a back view of a bracket, including a pressure sensor and an accelerometer, attached to a hockey stick used to determine a number of shot characteristics associated with shooting a hockey puck in accordance with one or more embodiments of the present disclosure.

FIG. 5C is an illustration of a bracket including a pressure sensor and an accelerometer used to determine a number of shot characteristics associated with shooting a hockey puck in accordance with one or more embodiments of the present disclosure.

### DETAILED DESCRIPTION

Devices, systems, and methods for determining a number of shot characteristics associated with shooting a hockey puck are described herein. In some examples, one or more embodiments can include a memory and a processor to execute instructions stored in the memory to determine shot characteristics including a shot time, a load time, a release time, and a shot score associated with shooting a hockey puck based upon data from a pressure sensor and an accelerometer on a bracket attached to a blade of a hockey stick.

Embodiments of the present disclosure can include attaching a bracket that includes a sensor (e.g., a force and/or pressure sensor) and an accelerometer to a hockey stick. A player can shoot hockey pucks using the hockey stick with the attached bracket. The bracket can also include a controller to receive data signals from the sensor and the accelerometer and a transceiver to transmit the data signals to a computing device for analysis to determine shot characteristics.

The shot characteristics that can be determined using the sensor data and the accelerometer data include a shot time metric, a release time metric, a load time metric, pressure metrics, acceleration metrics, a velocity metric, and/or a shot score metric. The shot time metric can be based on based on the amount of time between the first data signal from the sensor and/or accelerometer and a final signal from the accelerometer that is above a threshold acceleration value or when a signal from the accelerometer reaches zero. The release time metric can be based on the amount of time between the data signal from the sensor with the greatest magnitude and the final signal from the accelerometer that is above a threshold acceleration value or when a signal from the accelerometer reaches zero.

The load time metric can be based on the amount of time between the first data signal from the sensor and the data signal from the sensor with the greatest magnitude. The sensor metrics and acceleration metrics can include the magnitudes of the sensor data and the acceleration data over time and/or relative to sensor data and acceleration data of previously recorded and analyzed shots.

The velocity metric can include an estimated velocity based on the data from the accelerometer and the amount of time between the first data signal from the sensor and/or accelerometer and the final signal from the accelerometer that is above a threshold acceleration value or when a signal from the accelerometer reaches zero. The shot score metric can be based on the estimated velocity, the amount of time between receiving the first data signal from the sensor and/or accelerometer and the final signal from the accelerometer that is above a threshold acceleration value, and the amount of time between the data signal from the sensor with the greatest magnitude and the final signal from the accelerometer that is above the threshold acceleration value or when a signal from the accelerometer reaches zero.

The shot characteristics that can be determined according to embodiments of the present disclosure can be used to provide feedback and analysis of a player's shot so that the player can implement changes to improve their shot. The shot characteristics can also be used during hockey stick selection to identify the hockey stick that provides the best shot characteristics for a particular player.

In the following description, numerous details are set forth to provide an understanding of some embodiments of the present disclosure. It is to be understood that the following disclosure provides many different embodiments, or examples, for implementing different features of various embodiments. Specific examples of components and arrangements are described below to simplify the disclosure. These are merely examples and are not intended to be limiting. However, it will be understood by those of ordinary skill in the art that the system and/or methodology may be practiced without these details and that numerous variations or modifications from the described embodiments are possible. This description is not to be taken in a limiting sense, but rather made merely for the purpose of describing general principles of the implementations. The scope of the described implementations should be ascertained with reference to the issued claims.

As used herein, the terms “connect”, “connection”, “connected”, “in connection with”, and “connecting” are used to mean “in direct connection with” or “in connection with via one or more elements”; and the term “set” is used to mean “one element” or “more than one element”. Further, the terms “couple”, “coupling”, “coupled”, “coupled together”, and “coupled with” are used to mean “directly coupled together” or “coupled together via one or more elements”. As used herein, the terms “up” and “down”; “upper” and “lower”; “top” and “bottom”; and other like terms indicating relative positions to a given point or element are utilized to more clearly describe some elements. Commonly, these terms relate to a reference point for shooting a hockey puck, such as a surface from which the hockey puck is shot and/or a blade of the hockey stick relative to the player holding the stick, for example.

Language of degree used herein, such as the terms “approximately,” “about,” “generally,” and “substantially” as used herein represent a value, amount, or characteristic close to the stated value, amount, or characteristic that still performs a desired function or achieves a desired result. For example, the terms “approximately,” “about,” “generally,” and “substantially” may refer to an amount that is within less than 10% of, within less than 5% of, within less than 1% of, within less than 0.1% of, and/or within less than 0.01% of the stated amount.

These embodiments are described in sufficient detail to enable those of ordinary skill in the art to practice one or more embodiments of this disclosure. It is to be understood that other embodiments may be utilized and that process, electrical, and/or structural changes may be made without departing from the scope of the present disclosure.

As will be appreciated, elements shown in the various embodiments herein can be added, exchanged, combined, and/or eliminated so as to provide a number of additional embodiments of the present disclosure. The proportion and the relative scale of the elements provided in the figures are intended to illustrate the embodiments of the present disclosure and should not be taken in a limiting sense.

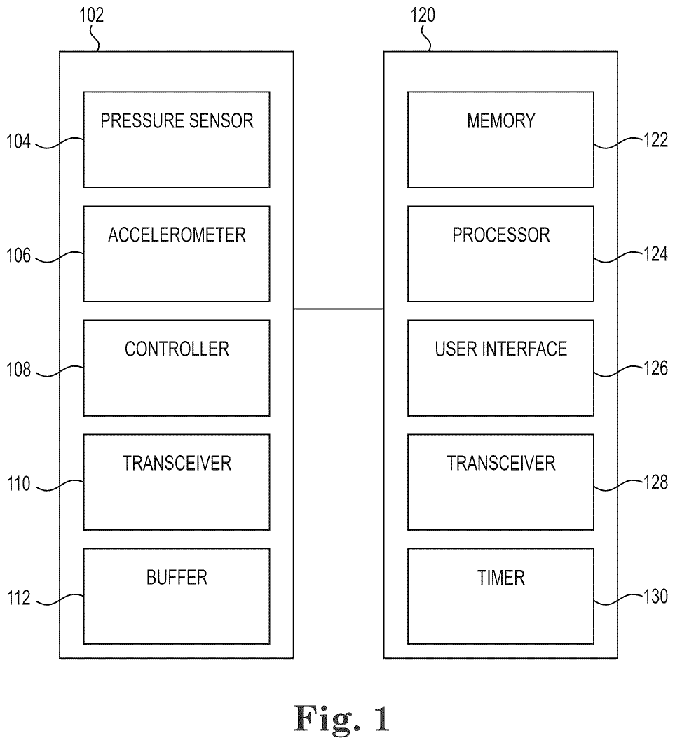

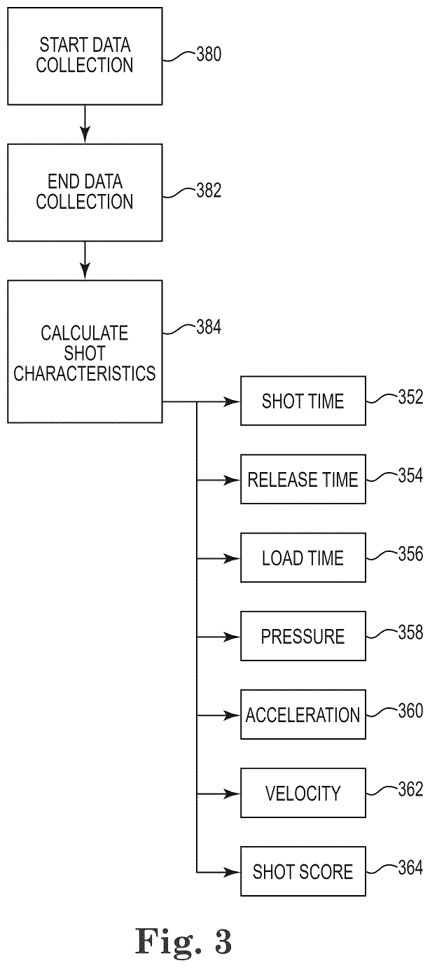

The figures herein follow a numbering convention in which the first digit or digits correspond to the drawing figure number and the remaining digits identify an element or component in the drawing. Similar elements or components between different figures may be identified by the use of similar digits. For example, 102 may reference element “02” in FIG. 1, and a similar element may be referenced as 302 in FIG. 3.

As used herein, “a”, “an”, or “a number of” something can refer to one or more such things, while “a plurality of” something can refer to more than one such things. For example, “a number of components” can refer to one or more components, while “a plurality of components” can refer to more than one component.

FIG. 1 is an example schematic representation of a system for determining a number of shot characteristics associated with shooting a hockey puck in accordance with one or more embodiments of the present disclosure. In FIG. 1, shot measurement device 102 can be a bracket and/or a holder that can be removeably mounted to a hockey stick. Shot measurement device 102 can also be embedded into a blade of hockey stick. The host measurement device 102 can include a pressure and/or force sensor 104, an accelerometer 106, a controller 108, a transceiver 110, and/or a buffer 112. The pressure and/or force sensor 104 can be positioned on a bottom surface of a hockey stick blade and can be used to measure the pressure and/or force applied to the blade of the hockey stick when shooting a hockey puck. The pressure and/or force sensor 104 can be a strain gauge sensor, a piezoelectric sensor, a capacitive force sensor, and/or a force sensing resistor sensor, among other types of sensors.

Accelerometer 106 can be configured to measure acceleration of the hockey stick blade when shooting a hockey puck. The acceleration measurement data can be used to determine the amount of time that it takes for a shot to be completed and estimate a velocity of the puck. Accelerometer 106 can be coupled to a bracket and attached to a back side (e.g., non-shooting side) of a blade of a hockey stick.

Controller 108 can include control circuitry that can be coupled to sensor 102 and accelerometer 106. Controller 108 can be configured to receive signals from sensor 102 and accelerometer 104. Controller 108 can be configured to process the signals from sensor 102 and accelerometer into data that represents measurements captured by sensor 102 and accelerometer 104. Controller 108 can be coupled to buffer 112 and configured to store data that represents measurements captured by sensor 102 and accelerometer 104 in buffer 112. Timer 130 can be configured to associate a time indicator with each portion of data that represents measurements captured by sensor 102 and accelerator 104. The time indicator associated with the data that represents measurements captured by sensor 102 and accelerator 104 can be stored together with the data that represents measurements captured by sensor 102 and accelerator 104. Controller 108 can be coupled to transceiver 110 and configured to wirelessly send data that represents measurements captured by sensor 102 and accelerometer 104 via the transceiver 110 to computing device 120. Computing device 120 can be wirelessly coupled to the shot measurement device 102 via transceiver 110 and computing device 120 can be at a physically remote location from the shot measurement device 102.

Computing device 120 can include memory 122, processor 124, a user interface 126, transceiver 128, and timer 130. Transceiver 128 on computing device 120 can be configured to wirelessly receive data that represents measurements captured by sensor 102 and accelerometer 104 from the shot measurement device 102. The data that represents measurements captured by sensor 102 and accelerometer 104 received by transceiver 128 can be stored in memory 122. The processor 124 can process data that represents measurements captured by sensor 102 and accelerometer 104 stored in memory 112 to determine shot characteristics associated with shooting a hockey puck. The processor 124 can be configured to execute computer readable instructions stored on a non-transitory computer readable medium to determine a shot time metric, a release time metric, a load time metric, pressure metrics, acceleration metrics, a velocity metric, and/or a shot score metric.

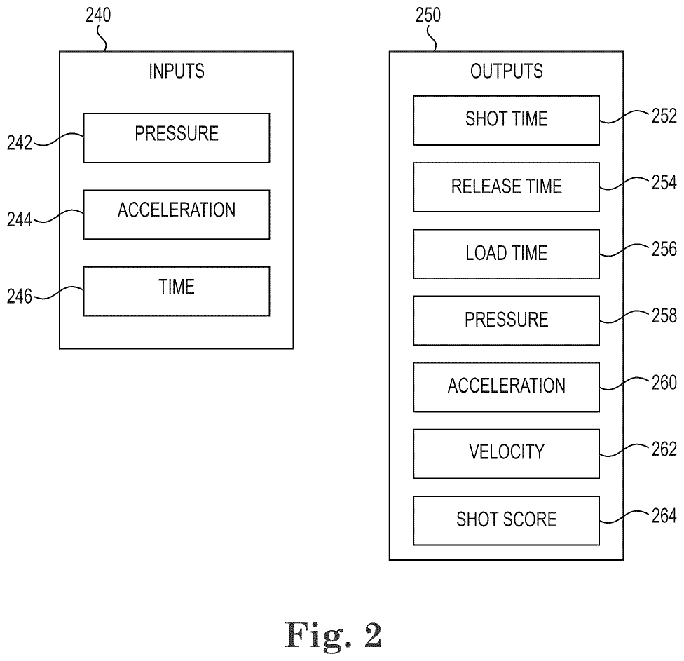

FIG. 2 illustrates a number of inputs and outputs used when determining a number of shot characteristics associated with shooting a hockey puck in accordance with one or more embodiments of the present disclosure. In FIG. 2, pressure and/or force data 242, acceleration data 244, and/or time data 246 can be inputs 240 used to determine shot characteristics.

Pressure and/or force data 242 can be generated by a sensor that is mounted on a bottom of a hockey stick blade. Force can be applied to the sensor and/or hockey stick blade when shooting a hockey puck and the pressure and/or force data 242 from the sensor can be used to determine shot characteristics of a hockey puck shot.

Acceleration data 244 can be generated by an accelerometer that is mounted on a back side of a hockey stick blade. The hockey stick blade is moved and accelerated when shooting a hockey puck and the acceleration data 244 can be used to determine shot characteristics of a hockey puck shot.

Time data 246 can be associated with the pressure and/or force data 242 and the acceleration data 244 such that each portion (e.g., each pressure and/or force measurement or each acceleration measurement) of pressure and/or force data 242 and the acceleration data 244 is associated with a time indicator. The time data 246 including time indicators associated with pressure and/or force data 242 and the acceleration data 244 can be used to determine shot characteristics of a hockey puck shot.

The shot characteristics outputs 250 that can be determined using the pressure and/or force data and the acceleration data include a shot time metric 252, a release time metric 254, a load time metric 256, pressure metrics 258, acceleration metrics 260, a velocity metric 262, and/or a shot score metric 264.

The shot time metric 252 can be based on based on the amount of time between the first data signal from the pressure sensor or the accelerometer and a final signal from the accelerometer that is above a threshold acceleration value or when a signal from the accelerometer reaches zero. The release time metric 254 can be based on the amount of time between the data signal from the pressure sensor with the greatest magnitude and the final signal from the accelerometer that is above a threshold acceleration value or when a signal from the accelerometer reaches zero.

The load time metric 256 can be based on the amount of time between the first data signal from the pressure sensor and the data signal from the pressure sensor with the greatest magnitude. The pressure metrics 258 and acceleration metrics 260 can include the magnitudes of the pressure data and the acceleration data over time and/or relative to pressure data and acceleration data of previously recorded and analyzed shots.

The velocity metric 262 can include an estimated velocity based on the data from the accelerometer and the amount of time between the first data signal from the pressure sensor and the final signal from the accelerometer that is above a threshold acceleration value or when a signal from the accelerometer reaches zero. The shot score metric 264 can be based on the estimated velocity, the amount of time between receiving the first data signal from the pressure sensor or accelerometer and the final signal from the accelerometer that is above a threshold acceleration value or when a signal from the accelerometer reaches zero, and the amount of time between the data signal from the pressure sensor with the greatest magnitude and the final signal from the accelerometer that is above the threshold acceleration value or when a signal from the accelerometer reaches zero.

FIG. 3 is a flow diagram of a method for determining hockey puck shot characteristics in accordance with one or more embodiments of the present disclosure. A method for determining hockey puck shot characteristics can include starting data collection 380. Data collection can include transmitting pressure and/or force data and acceleration data from the shot measurement device to the computing device. For a particular shot, data collection can begin when a pressure measurement is sensed and transmitted from the shot measurement device to the computing device and/or when acceleration measurements transmitted from the shot measurement device to the computing device are above a threshold. Therefore, acceleration data and/or pressure/force data can be a trigger to begin data collection. Data from the sensor and/or accelerometer can be transmitted to and stored on the computing device at periodic intervals, such as every 0.5 milliseconds (ms).

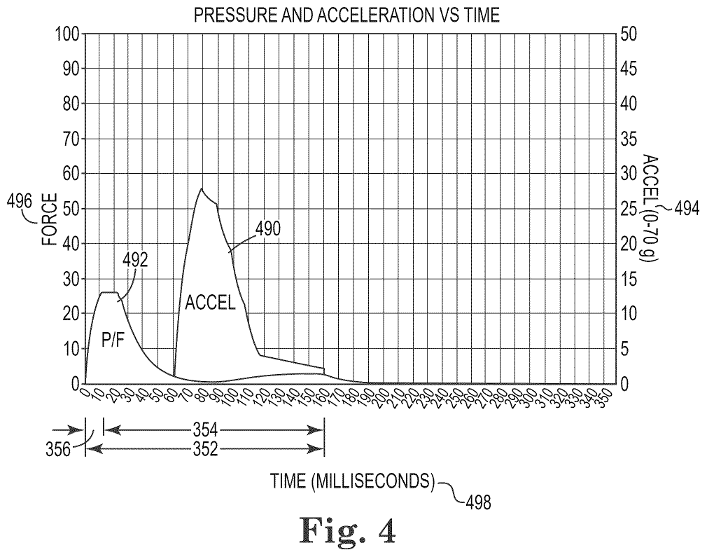

The method can include ending data collection 382 once 500 data points from the sensor and/or accelerometer have been transmitted to and stored on the computing device. Those 500 data points (as shown the graph in FIG. 4) can be used to calculate hockey shot characteristics 384. The shot time metric 352 can be based on based on the amount of time between the first data signal from the pressure sensor and a final signal from the accelerometer that is above a threshold acceleration value (shown in FIG. 4) or when a signal from the accelerometer reaches zero. The release time metric 354 can be based on the amount of time between the data signal from the pressure sensor with the greatest magnitude and the final signal from the accelerometer that is above a threshold acceleration value or when a signal from the accelerometer reaches zero.

The load time metric 356 can be based on the amount of time between the first data signal from the pressure sensor and the data signal from the pressure sensor with the greatest magnitude. The pressure metrics 358 and acceleration metrics 360 can include the magnitudes of the pressure data and the acceleration data over time and/or relative to pressure data and acceleration data of previously recorded and analyzed shots (shown in FIG. 4 as pressure/force (P/F) data 492 and acceleration data 490).

The velocity metric 362 can include an estimated velocity based on the data from the accelerometer (acceleration data 490 shown in FIG. 4) and the amount of time between the first data signal from the pressure sensor and the final signal from the accelerometer that is above a threshold acceleration value or when a signal from the accelerometer reaches zero (shown as the shot time metric 352 in FIG. 4). For example, the velocity metric 362 can be calculated by the following formula: Velocity=k*average of the acceleration data 490 for the shot measured in gravitational units (g)*(32.17 ft/s²)/g*3600 s/hr*1 mi/5280 ft*1 s/1000 ms*(Sₑₜ ms−Sₛₛ ms). The unit abbreviations at feet (ft), seconds(s), hour (hr), mile (mi), and milliseconds (ms). k is a unit less constant that can represent the percentage of force transferred from the blade to the hockey puck when shooting the puck. For example, a k value of 1 indicates 100% of the force from the blade is transferred to the hockey puck when shooting the hockey puck and a k value of 0.9 indicates 90% of the force from the blade is transferred to the hockey puck when shooting the hockey puck. Sₑₜ is the shot end time which corresponds to the time when the final signal from the accelerometer that is above a threshold acceleration value or when a signal from the accelerometer reaches zero. Sₛₛ is the shot start time which corresponds to a time of the first data signal from the pressure/force sensor or a time of the first data signal from the accelerometer that is above a threshold. The formula is derived for calculating a velocity in miles per hour, but any other units could be used to calculate the velocity.

For the shot data illustrated in FIG. 4, the estimated velocity 362 can be 25.3 mph (miles per hour) based the result of the following formula: 7.2 g average acceleration*32.17 ft/s²/g*3600 s/hr*1 mi/5280 ft*160 ms shot time*1 s/1000 ms.

The shot score metric 364 can be based on the estimated velocity (e.g., velocity metric 362), the amount of time between receiving the first data signal from the pressure sensor and the final signal from the accelerometer that is above a threshold acceleration value or when a signal from the accelerometer reaches zero (shown as the shot time metric 352 in FIG. 4), and the amount of time between the data signal from the pressure sensor with the greatest magnitude and the final signal from the accelerometer that is above the threshold acceleration value or when a signal from the accelerometer reaches zero (shown as the release time metric 354 in FIG. 4). For example, the shot score 364 for the shot data illustrated in FIG. 4 is 320.5. The shot score provides a unitless relative measurement that can be used to compare shots to each other using the metrics calculated according to embodiments of the present disclosure.

FIG. 4 is a graph illustrating sensor data and acceleration data used to determine hockey shot characteristics in accordance with one or more embodiments of the present disclosure. FIG. 4 illustrates the 500 data points collected from the pressure/force sensor and the accelerometer over a time period associated with a particular hockey shot. The pressure/force data 492 includes 500 data points collected every 0.5 ms and the acceleration data 490 includes 500 data points collected every 0.5 ms. The number of data points collected and/or the time interval between data points can vary and/or change based on a number of factors, including the shooting ability of the user and/or the need to increase or decrease the quantity or frequency of data collection in order to provide improved shot characteristic metrics. The force/pressure data 496 shown on the y-axis on the left hand side of FIG. 4 can be shown on a relative scale based on maximum pressure that the sensor is able to record (e.g., a percentage of the maximum pressure/force for the pressure/force sensor). The acceleration data 494 shown in the y-axis on the right hand side of FIG. 4 can be shown in units of the gravitational constant (g). The time data 498 shown on the x axis of FIG. 4 can be over a time period where the 500 data points shown in FIG. 4 are collected. FIG. 4 illustrates shot time 352 of 160 ms which corresponds to a shot end time of 160 ms on the graph minus a shot start time of 0 ms on the graph. FIG. 4 illustrates a release time 354 of 148 ms which corresponds to a shot end time of 160 ms on the graph minus a peak pressure time of 120 ms on the graph. FIG. 4 illustrates a load time 356 of 12 ms which corresponds to a peak pressure time of 12 ms minus a shot start time of 0 ms on the graph.

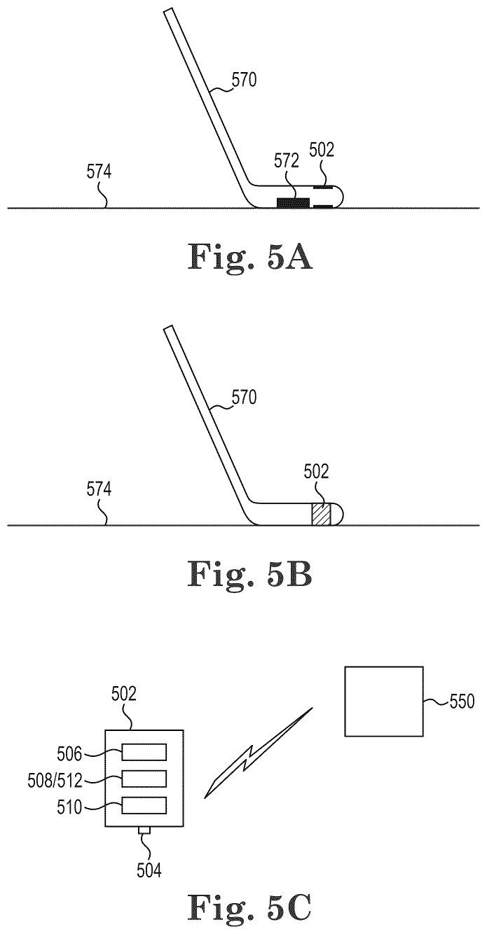

FIG. 5A is a front view of a bracket, including a pressure sensor and an accelerometer, attached to a hockey stick used to determine a number of shot characteristics associated with shooting a hockey puck in accordance with one or more embodiments of the present disclosure. In FIG. 5A, hockey stick 570 can be used to shoot a hockey puck 572 resting on surface 574. The surface 574 can be ice in an ice rink, concrete in a driveway, and/or a synthetic ice surface in a hockey training facility, for example, among other types of surfaces from which a hockey puck 572 can be shot. Shot measurement device 502 includes a pressure and/or force sensor, an accelerometer, a timer, a controller, a buffer and/or a transceiver can be attached to the blade of the hockey stick. Shot measurement device 502 can be attached to the blade of the hockey stick such that it does not interfere or has negligible interference with a portion of the blade that contacts the puck when taking a shot. The pressure and/or force sensor of the shot measurement device can be located on a portion of the shot measurement device 502 that is attached to bottom of the hockey stick blade, such that the pressure and/or force sensor contacts surface 574 when shooting the puck 572. The pressure and/or force sensor can also be embedded into the bracket and/or the blade of the hockey stick. The bracket can include a raised bottom surface near the front edge of the bracket that can allow force to be transferred from the raised bottom surface of the bracket to the pressure sensor in the bracket when shooting the puck while tilting the hockey stick and/or blade forward towards the direction of the shot.

FIG. 5B is a back view of a bracket, including a pressure sensor and an accelerometer, attached to a hockey stick used to determine a number of shot characteristics associated with shooting a hockey puck in accordance with one or more embodiments of the present disclosure. In FIG. 5B, shot measurement device 502 can be attached to the blade of the hockey stick 570 such that an accelerometer, a timer, a controller, a buffer and/or a transceiver are on the back side of the hockey stick and therefore do not interfere with front of the blade that contacts the puck (not shown) resting on surface 574 when taking a shot.

FIG. 5C is an illustration of a bracket including a pressure sensor and an accelerometer used to determine a number of shot characteristics associated with shooting a hockey puck in accordance with one or more embodiments of the present disclosure. In FIG. 5C, shot measurement device 502 includes a pressure and/or force sensor 504, an accelerometer 506, a timer, a controller 508, a buffer 512 and/or a transceiver 512 in communication with computing device 520. Shot measurement device 502 can be configured to wirelessly send data that represents measurements captured by sensor 502 and accelerometer 304 via the transceiver 510 to computing device 520.

Although specific embodiments have been illustrated and described herein, those of ordinary skill in the art will appreciate that any arrangement calculated to achieve the same techniques can be substituted for the specific embodiments shown. This disclosure is intended to cover any and all adaptations or variations of various embodiments of the disclosure.

It is to be understood that the above description has been made in an illustrative fashion, and not a restrictive one. Combination of the above embodiments, and other embodiments not specifically described herein will be apparent to those of skill in the art upon reviewing the above description.

The scope of the various embodiments of the disclosure includes any other applications in which the above structures and methods are used. Therefore, the scope of various embodiments of the disclosure should be determined with reference to the appended claims, along with the full range of equivalents to which such claims are entitled.

In the foregoing Detailed Description, various features are grouped together in example embodiments illustrated in the figures for the purpose of streamlining the disclosure. This method of disclosure is not to be interpreted as reflecting an intention that the embodiments of the disclosure require more features than are expressly recited in each claim.

Rather, as the following claims reflect, inventive subject matter lies in less than all features of a single disclosed embodiment. Thus, the following claims are hereby incorporated into the Detailed Description, with each claim standing on its own as a separate embodiment.

What is claimed:

1. An apparatus, comprising:
a memory; and
a processor configured to execute executable instructions stored in the memory to:
capture data from a sensor and an accelerometer associated with a blade of a hockey stick; and
determine a number of shot characteristics associated with shooting a hockey puck with the hockey stick based on the data captured from the sensor and the accelerometer.

2. The apparatus of claim 1, wherein the sensor is configured to measure force and/or pressure applied to the blade of the hockey stick and the apparatus includes a timer that is started in response to the processor receiving a first data signal from the sensor or the accelerometer.

3. The apparatus of claim 1, wherein the number of shot characteristics include a shot time based on an amount of time between receiving a first data signal from the sensor and receiving a final signal from the accelerometer above a threshold acceleration value or when a signal from the accelerometer reaches zero.

4. The apparatus of claim 1, wherein the number of shot characteristics include a release time based on an amount of time between receiving a data signal from the sensor with a greatest magnitude and receiving a final signal from the accelerometer above a threshold acceleration value.

5. The apparatus of claim 1, wherein the number of shot characteristics include a load time based on an amount of time between receiving a first data signal from the sensor and receiving a data signal from the sensor with a greatest magnitude.

6. The apparatus of claim 1, wherein the number of shot characteristics include an estimated velocity based on the data from the accelerometer and an amount of time between receiving a first data signal from the sensor and receiving a final signal from the accelerometer above a threshold acceleration value or when a signal from the accelerometer reaches zero.

7. The apparatus of claim 6, wherein the number of shot characteristics include a shot score based on the estimated velocity, an amount of time between receiving a first data signal from the pressure sensor and receiving a final signal from the accelerometer above a threshold acceleration value or when a signal from the accelerometer reaches zero, and an amount of time between receiving a data signal from the pressure sensor with a greatest magnitude and receiving the final signal from the accelerometer above the threshold acceleration value or when a signal from the accelerometer reaches zero.

8. The apparatus of claim 1, wherein the data is transmitted wirelessly from a bracket attached to the blade of the hockey stick and wherein the bracket includes the sensor, the accelerometer, and a wireless transmitter.

9. A non-transitory computer readable medium having computer readable instructions stored thereon that are executable by a processor to:
capture data accumulated over a particular time period from a sensor and an accelerometer associated with a blade of a hockey stick, wherein the data is associated with shooting a hockey puck with the hockey stick; and
determine a number of shot characteristics associated with shooting the hockey puck with the hockey stick based on the data captured from the sensor and the accelerometer.

10. The non-transitory computer readable medium of claim 9, wherein the computer readable instructions are executable by the processor to determine a pressure score based on the data from the sensor.

11. The non-transitory computer readable medium of claim 9, wherein the computer readable instructions are executable by the processor to determine a load score based on:
a load time including an amount of time between receiving a first data signal from the sensor and receiving a data signal from the sensor with a greatest magnitude; and
a shot time including an amount of time between receiving the first data signal from the sensor and receiving a final signal from the accelerometer above a threshold acceleration value or when a signal from the accelerometer reaches zero.

12. The non-transitory computer readable medium of claim 9, wherein the computer readable instructions are executable by the processor to determine a release score based on:
a release time including an amount of time between receiving a data signal from the sensor with a greatest magnitude and a data signal from the accelerometer with a greatest magnitude; and
a shot time including an amount of time between receiving the first data signal from the sensor and receiving a final signal from the accelerometer above a threshold acceleration value or when a signal from the accelerometer reaches zero.

13. The non-transitory computer readable medium of claim 9, wherein the computer readable instructions are executable by the processor to determine an estimated velocity based on:
the data from the accelerometer; and
an amount of time between receiving a first data signal from the sensor and receiving a final signal from the accelerometer above a threshold acceleration value or when a signal from the accelerometer reaches zero.

14. The non-transitory computer readable medium of claim 9, wherein the computer readable instructions are executable by the processor to determine a shot score based on an estimated velocity, a release time, and a shot time.

15. The non-transitory computer readable medium of claim 9, wherein in wherein the computer readable instructions are executable by the processor to output the determined number of shot characteristics to a user interface.

16. A system, comprising:
a bracket attached to a blade of a hockey stick, wherein the bracket includes:
a sensor,
an accelerometer, and
a wireless transceiver;
a computing device including:
a memory; and
a processor configured to execute executable instructions stored in the memory to:
receive data associated with the sensor and the accelerometer of the bracket attached to the blade of the hockey stick; and
determine a number of shot characteristics associated with shooting a hockey puck with the hockey stick based on the data associated with the pressure sensor and the accelerometer.

17. The system of claim 16, wherein the wireless transmitter sends the data associated with the sensor and the accelerometer to the computing device.

18. The system of claim 16, wherein the determined number of shot characteristics are stored in the memory of the computing device.

19. The system of claim 16, wherein the processor is configured to start a timer in response to receiving a first signal associated with data from the sensor and stop the timer in response to receiving a final signal from the accelerometer above a threshold acceleration value or when a signal from the accelerometer reaches zero.

20. The system of claim 19, wherein the number of shot characteristics for a particular shot are based upon data received during a time period between starting the timer and stopping the timer.
